(19) United States
(12) Patent Application Publication
(10) Pub. No.: US 2008/0130891 A1
(43) Pub. Date: Jun. 5, 2008

(54) INTEGRATED CIRCUIT DEVICE INTERFACE WITH PARALLEL SCRAMBLER AND DESCRAMBLER

(76) Inventors: Alvin Sun, San Jose, CA (US); Steven Pan, Santa Clara, CA (US); Frank Lin, Santa Clara, CA (US)

Correspondence Address: WILSON & HAM, 2530 BERRYESSA ROAD, PMB: 348, SAN JOSE, CA, 95132, US

(21) Appl. No.: 11/935,303

(22) Filed: Nov. 5, 2007

Related U.S. Application Data
(60) Provisional application No. 60/856,524, filed on Nov. 3, 2006.

(51) Int. Cl. H04K 1/04

(52) U.S. Cl. 380/268

(57) ABSTRACT

An interface for an integrated circuit (IC) device. The interface includes a scrambler to combine a plurality of plaintext data streams and a pseudorandom key sequence. The scrambler includes a pseudorandom number (PRN) source and a combiner. The PRN source provides a pseudorandom number. The pseudorandom key sequence is based on the pseudorandom number. The combiner receives the plurality of plaintext data streams in parallel and output a corresponding plurality of ciphertext data streams in parallel to another IC device interface. The interface also may include a descrambler to separate a pseudorandom key sequence out of a plurality of parallel ciphertext data streams. By scrambling plaintext data streams and descrambling ciphertext data streams in parallel, the data transmission rate on the IC device may be slower than a data transmission rate used to transfer data between IC devices.

### CROSS-REFERENCE TO RELATED APPLICATIONS

This application is entitled to the benefit of provisional U.S. Patent Application Ser. No. 60/856,524, filed Nov. 3, 2006, the disclosure of which is incorporated by reference herein in its entirety.

### BACKGROUND OF THE INVENTION

Stream ciphering is used in data transmissions to randomize the data spectrum by adding a pseudorandom key sequence to the plaintext sequence transmitted by the protocol layers. System Packet Interface Level 5 (SPI-5) is one type of interface for packet and cell transfers between a physical layer device (PHY) and a link layer device. FIG. 1 illustrates a conventional SPI-5 system 10. The depicted SPI-5 system 10 includes a link layer device 12, a PHY 14, and a serializer/deserializer (SERDES) 16. The link layer device 12 includes a transmit link layer device 20 and a receive link layer device 22. The system packet interface 18, which includes a transmit interface 24 and a receive interface 26, is between the link layer device 12 and the PHY 14. In general, the transmit link layer device 20 sends data to the PHY 14 via the transmit interface 24 of the system packet interface 18. The PHY 14 returns status information to the transmit link layer device 20 via an independent status channel. The PHY 14 also sends data to the receive link layer device 22 via the receive interface 26 of the system packet interface 18, and the receive link layer device 22 returns status information to the PHY 14 via an independent status channel. A SERDES framer interface (e.g., SFI-5) is implemented between the PHY 14 and the SERDES 16.

FIG. 2 illustrates additional details of the transmit interface 24 and the receive interface 26 of the system packet interface 18 between the link layer device 12 and the PHY 14. In particular, the transmit data path of the transmit interface 14 includes transmit data bus TDAT[15:0], a transmit control channel TCTL, and a transmit clock channel TDCLK. Similarly, the receive data path of the receive interface 26 includes a receive data bus RDAT[15:0], a receive control channel RCTL, and a receive clock channel RDCLK.

FIG. 3 illustrates a conventional stream cipher architecture 30 that may be used in a conventional SPI-5 system such as the SPI-5 system 10 of FIG. 1. The depicted stream cipher architecture 30 includes a scrambler 32 to add a pseudorandom key sequence to a plaintext data stream. In particular, the conventional scrambler 32 uses an exclusive-or (XOR) logic block 34 to combine the plaintext data stream with the pseudorandom key sequence from a linear feedback shift register (LFSR) 36. The XOR operation processes the plaintext data stream one bit at a time in a serial manner. The scrambler 32 then transmits a ciphertext, based on the encoded plaintext, from the transmit link layer device 20 to the PHY 14.

The stream cipher architecture 30 also includes a descrambler 38 of the receive interface 26 to extract the pseudorandom key sequence from the ciphertext in order to recover the plaintext data stream. It should be noted that the depicted descrambler 38 represents a descrambler on a separate chip interface. In this way, the scrambler 32 generates ciphertext at a first chip interface and sends the ciphertext to the descrambler 38 at a distinct chip interface to recover the plaintext data stream from the ciphertext. The depicted descrambler 38 includes lock acquisition logic 40, a LFSR 42, and a subtractor 44 or other type of separator. Thus, a plaintext data stream may be scrambled, for example, by modulo 2 addition of a pseudorandom sequence with the plaintext data stream at the scrambler 32 and then recovered, for example, by modulo 2 subtraction of the identical pseudorandom sequence from the ciphertext at the descrambler 38.

FIG. 4 illustrates a conventional LFSR 36 for use in the scrambler 32 of FIG. 3 to generate the pseudorandom key sequence. In general, the conventional scrambler 32 uses a common X´11+X´9+1 LFSR stream cipher. The depicted LFSR 36 shows a serial implementation of the scrambler 32 for operation on one of the signals in the source device of the transmit interface 24. The plaintext data is designated as “D[0],” the pseudorandom key sequence is designated as “S[1]” through “S[11],” and the ciphertext data is designated as “C[0].” The scrambler 32 advances by one position every bit time, so that each bit of the plaintext data stream is added to the next bit of the pseudorandom key sequence. To recover the plaintext data stream from the ciphertext data stream at the descrambler 38, each signal in the data path of the receive interface 26 is descrambled by an independent X´11+X´9+1 LFSR stream cipher. Like the scrambler 32, the descrambler 38 advances by one position every bit time. When the descrambler 38 is in the locked state, according to the lock acquisition logic 40, the LFSR 42 in the descrambler 38 is synchronized to the LFSR 36 in the scrambler 32. Synchronization of the descrambler 38 can be achieved by using a known SPI-5 training pattern and procedure.

Although conventional designs use single-bit scramble and descramble logic, these single-bit implementations do not operate well in high frequency (e.g., 2.488-3.125 GHz) environments. For example, some implementations use complex logic located at a corresponding current mode logic (CML) pad area to decode the encoded signal. Additionally, in an application specific integrated circuit (ASIC) implementation, the logic design can be very challenging. In field programmable gate array (FPGA) applications, SPI-5 standards are not implemented in the high speed pad area (SERDES).

### SUMMARY OF THE INVENTION

Embodiments of a system are described. In one embodiment, the system is an integrated circuit (IC) device interface. An embodiment of the system includes a scrambler. The scrambler combines a plurality of plaintext data streams and a pseudorandom key sequence. The scrambler includes a pseudorandom number (PRN) source and a combiner coupled to the PRN source. The PRN source provides a pseudorandom number. The pseudorandom key sequence is based on the pseudorandom number. The combiner receives the plurality of plaintext data streams in parallel and outputs a corresponding plurality of ciphertext data streams in parallel.

Another embodiment of the system includes a descrambler. The descrambler separates a pseudorandom key sequence out of a plurality of parallel ciphertext data streams. The descrambler includes a PRN source and key stream logic coupled to the PRN source. The PRN source provides a pseudorandom number. The pseudorandom key sequence is based on the pseudorandom number. The key stream logic receives the plurality of parallel ciphertext data streams and generates a corresponding plurality of parallel plaintext data streams. Other embodiments of the system include both the scrambler and the descrambler. Other embodiments of the system are also described.

Embodiments of a method are also described. In one embodiment, the method is a method for implementing a transmit interface for an integrated circuit (IC) device. An embodiment of the method includes receiving a plurality of plaintext data streams in parallel at a first data transmission rate, obtaining a pseudorandom key sequence, combining the plurality of plaintext data streams with at least a portion of the pseudorandom key sequence to generate a corresponding plurality of ciphertext data streams in parallel, and outputting the plurality of ciphertext data streams in parallel at the first data transmission rate.

In another embodiment, the method is a method for implementing a receive interface for an integrated circuit (IC) device. An embodiment of the method includes receiving a plurality of ciphertext data streams in parallel at a first data transmission rate, obtaining a pseudorandom key sequence, extracting the pseudorandom key sequence from each of the plurality of parallel ciphertext data streams to generate a corresponding plurality of plaintext data streams in parallel, and outputting the plurality of plaintext data streams in parallel at the first data rate. Other embodiments of the method are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 illustrates a conventional system packet interface level 5 (SPI-5) system.

FIG. 2 illustrates additional details of the transmit interface and the receive interface of the system packet interface between the link layer device and the PHY.

FIG. 3 illustrates a conventional stream cipher architecture that may be used in a conventional SPI-5 system such as the SPI-5 system of FIG. 1.

FIG. 4 illustrates a conventional linear feedback shift register (LFSR) for use in the scrambler of FIG. 3 to generate the pseudorandom key sequence.

FIG. 5 depicts a schematic diagram of one embodiment of an integrated circuit (IC) device with an input/output (I/O) interface.

FIG. 6 depicts a schematic diagram of one embodiment of the transmit interface of the I/O interface of FIG. 5.

FIG. 7 depicts a schematic diagram of one embodiment of the receive interface of the I/O interface of FIG. 5.

FIG. 8 depicts a schematic diagram of one embodiment of the scrambler of the transmit interface of FIG. 6.

FIG. 9 depicts a schematic diagram of one embodiment of the descrambler of the receive interface of FIG. 7.

FIG. 10 depicts a state diagram of one embodiment of a descrambler process that may be implemented by the descrambler of FIG. 9.

FIG. 11 depicts a schematic diagram of another embodiment of the descrambler of FIG. 7.

FIG. 12 depicts a schematic diagram of one embodiment of a pseudorandom key sequence that may be implemented in a pseudorandom number source within the scrambler of FIG. 8 and the descrambler of FIG. 9.

FIG. 13 depicts a schematic diagram of one embodiment of an integrated circuit (IC) device with a read-only memory (ROM) that may be implemented in a pseudorandom number source within the scrambler of FIG. 8 and the descrambler of FIG. 9.

FIG. 14 depicts a schematic diagram of one embodiment of a chip to implement the transmit interface of FIG. 5.

FIG. 15 depicts a flow chart diagram of one embodiment of a method for implementing a transmit interface.

FIG. 16 depicts a flow chart diagram of one embodiment of a method for implementing a receive interface.

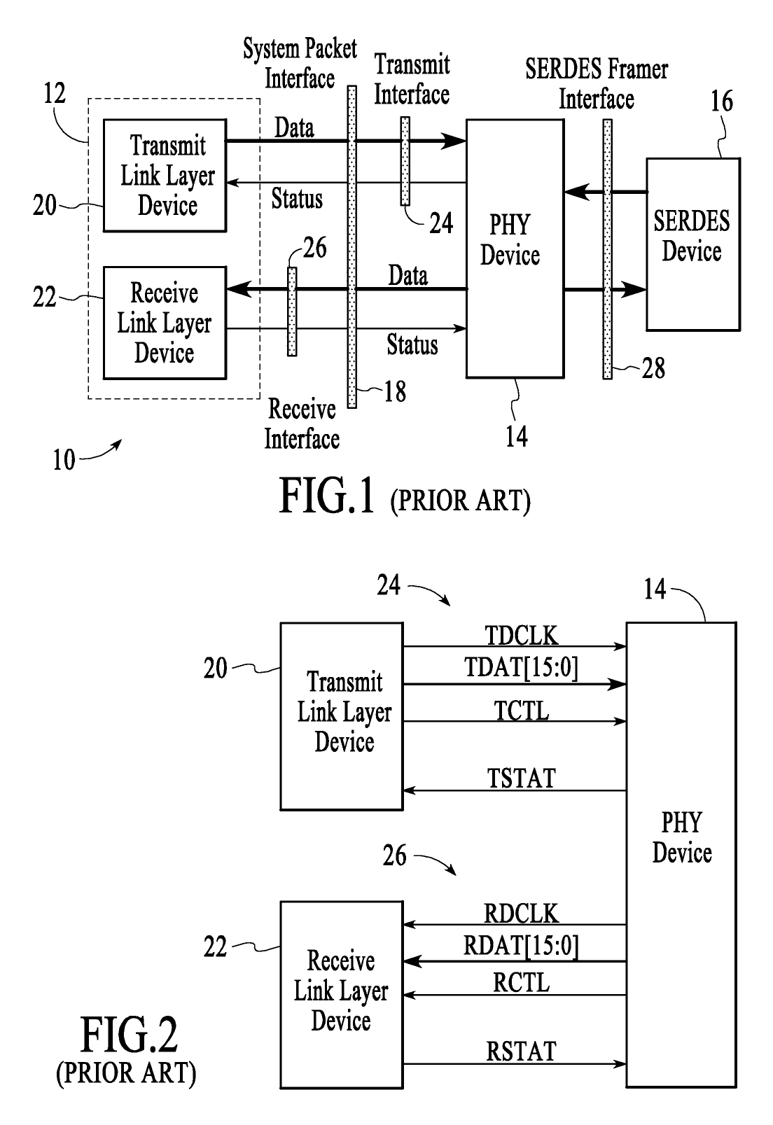

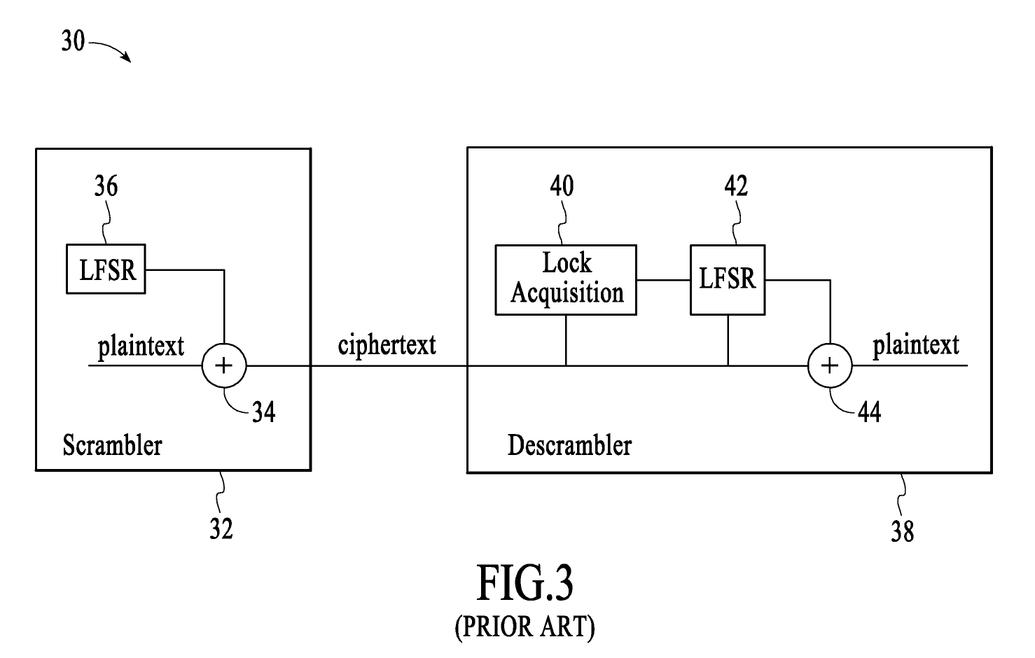

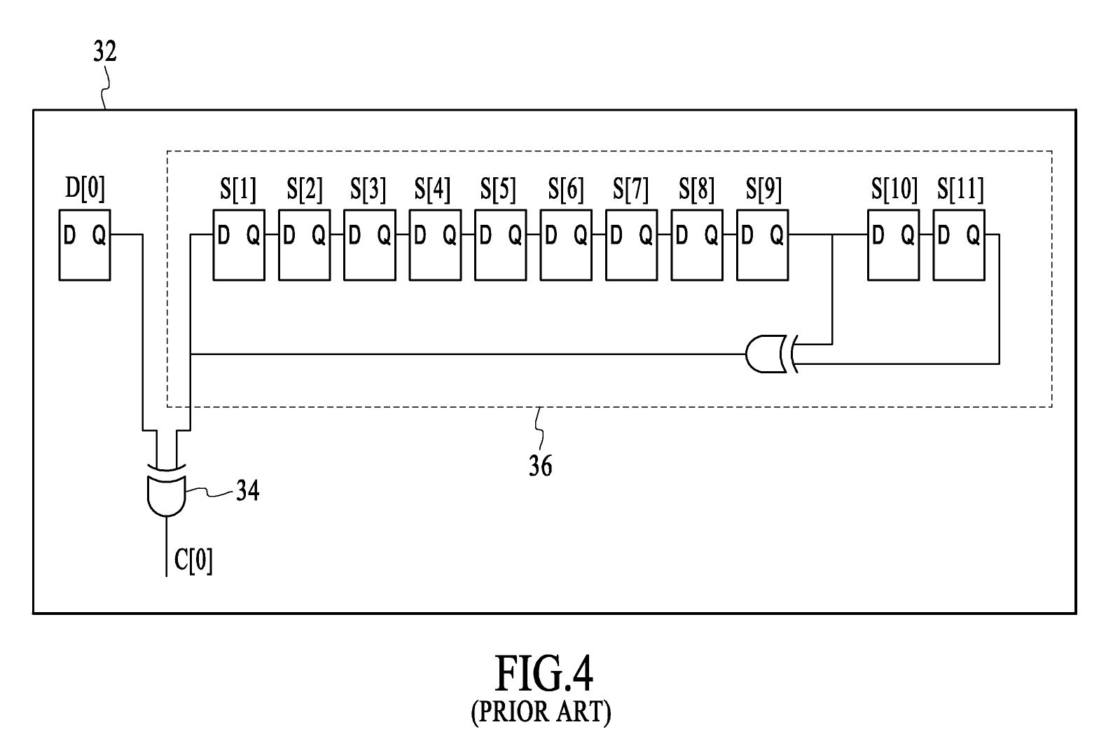

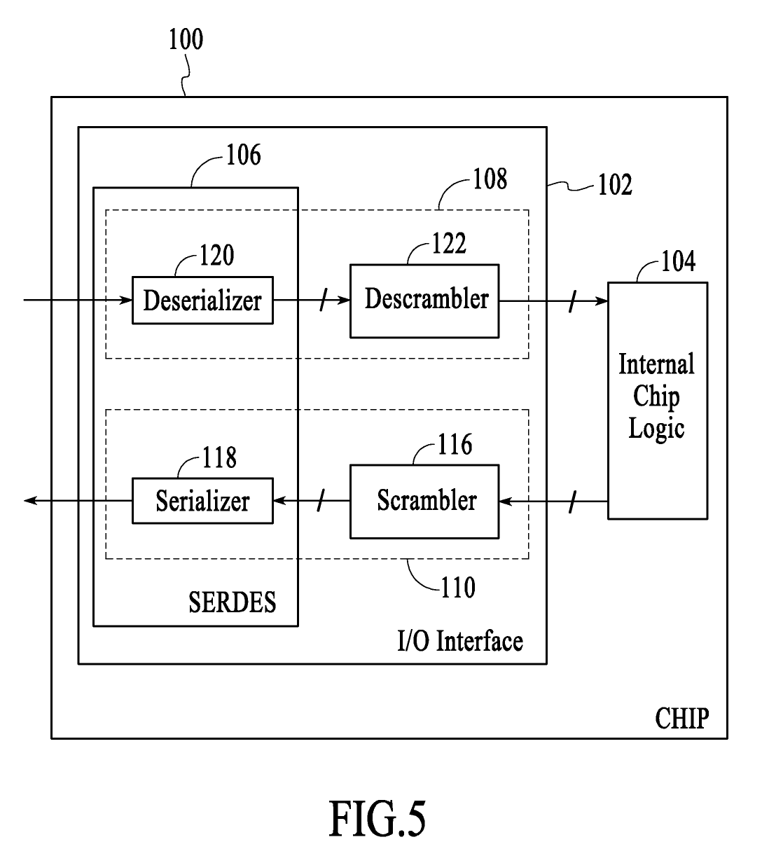

Throughout the description, similar reference numbers may be used to identify similar elements.

### DETAILED DESCRIPTION

FIG. 5 depicts a schematic diagram of one embodiment of an integrated circuit (IC) device 100 with an input/output (I/O) interface 102. The IC device 100 is also referred to as an IC chip. Although the IC device 100 is shown and described with certain component parts and functionality, other embodiments of the IC device 100 may be implemented with more or less component parts and may be configured to impart more or less functionality. Some exemplary implementations of the IC device 100 include a network processor IC, a switch fabric IC, and a physical layer (PHY) IC, although the IC device 100 may be implemented in another type of chip.

The illustrated IC device 100 includes the I/O interface 102 and internal chip logic. In general, the I/O interface 102 receives data from and transmits data to other IC devices. The I/O interface 102 also interfaces with the internal chip logic 104, which processes data to perform one or more functions. As an example, the internal chip logic 104 may implement a network traffic manager or another type of network processing functions.

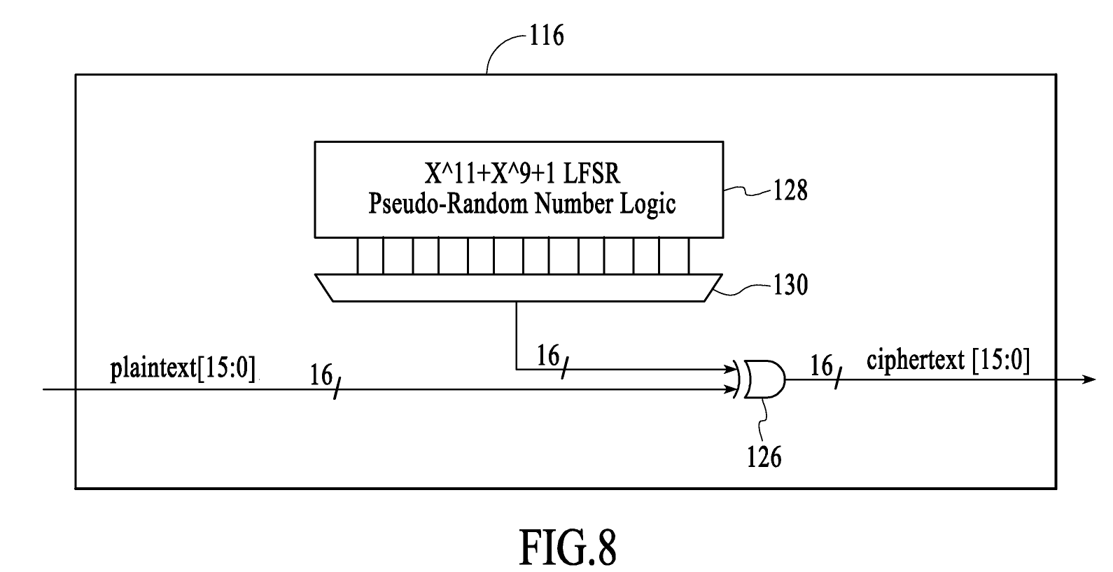

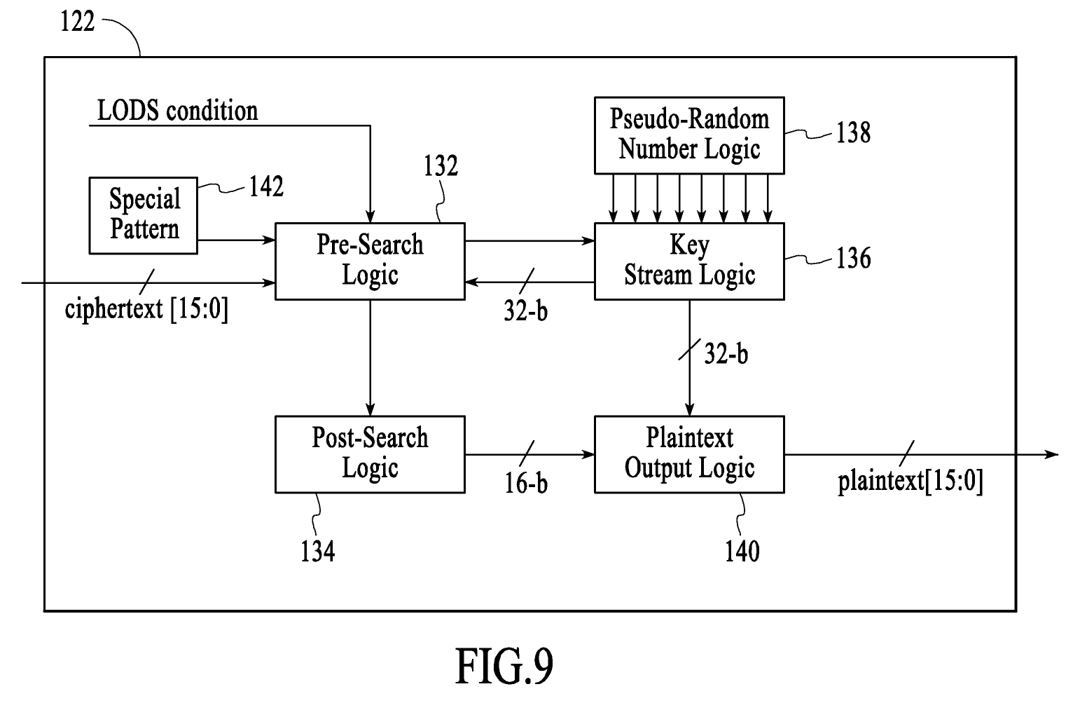

The I/O interface 102 includes a serializer/deserializer (SERDES) 106. The I/O interface 102 also includes receive interface 108 (designated by the top dashed box) and a transmit interface 110 (designated by the bottom dashed box). Although the receive and transmit interfaces 108 and 110 are described as functional units, the receive and transmit interfaces 108 and 110 may be implemented using disparate components. For example, the transmit interface 110 may include a scrambler 116 and a separate serializer 118 from the SERDES 106. Similarly, the receive interface 108 may include a deserializer 120 from the SERDES 106 and a separate descrambler 122. Examples of the descrambler 122 and scrambler 116 are shown in FIGS. 8 and 9, respectively, and are described in more detail below.

In one embodiment, the receive interface 108 receives an SPI-5 signal. The incoming SPI-5 signal is a serial ciphertext data stream that is a combination of plaintext encoded with a pseudorandom key sequence. The receive interface 108 may receive the incoming SPI-5 serial ciphertext using a known standard (e.g., 40 G or 4×10 G). In general, the receive interface 108 extracts the pseudorandom key sequence from the incoming ciphertext data stream and passes plaintext data streams to the internal chip logic 104 in parallel.

It should be noted that the figures described herein designate parallel communication channels (e.g., multi-bit busses) with a hash mark across the line indicated as the communication channel. For example, the communication channels between the deserializer 120 and the descrambler 122, between the descrambler 122 and the internal chip logic 104, between the internal chip logic 104 and the scrambler 116, and between the scrambler 116 and the serializer 118 are each indicated as parallel communication channels. Alternatively, a parallel communication channel may be designated by the number of bits indicated for a particular communication channel. Exemplary bit widths for the parallel communication channels are 16 bits and 32 bits. However, some embodiments of the parallel communication channels may transmit a different number of bits in parallel. In contrast, the communication channel into the deserializer 120 and the communication line out of the serializer 118 are not parallel communication channels. Rather these lines are serial channels which send data in series one bit at a time.

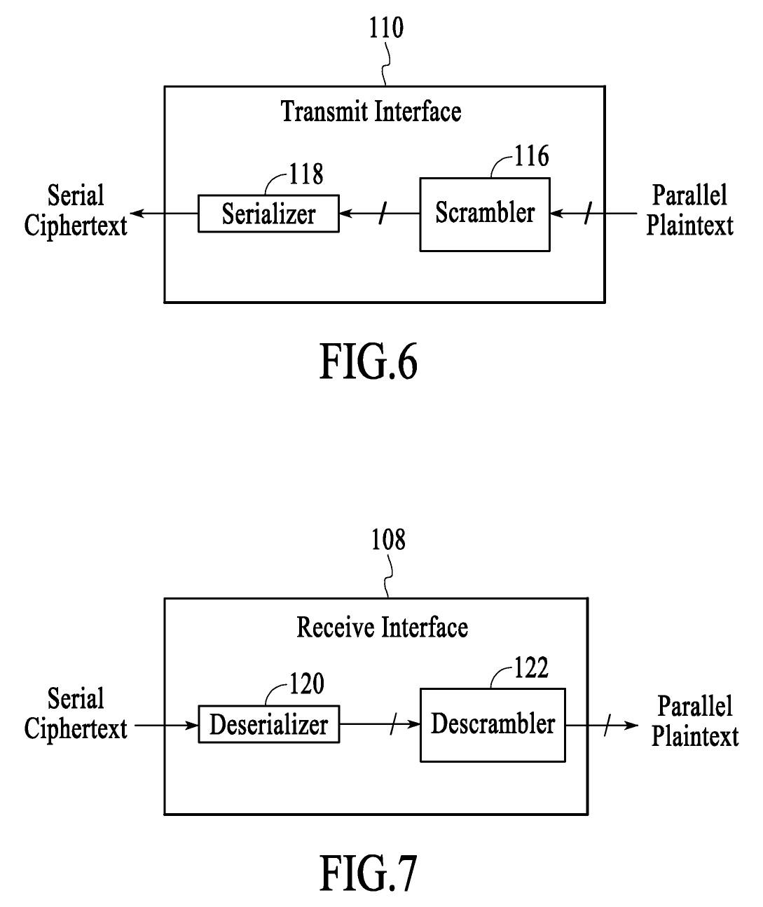

After processing, the internal chip logic 104 passes plaintext data streams in parallel to the transmit interface 110. The transmit interface 110 then scrambles the plaintext data streams to generate one or more ciphertext data streams and sends the ciphertext data stream to another I/O interface of another IC device. More specifically, the transmit interface 110 scrambles the plaintext data streams with a pseudorandom key sequence. Exemplary embodiments of the transmit interface 110 and the receive interface 108 are shown in FIGS. 6 and 7 and described in more detail below.

FIG. 6 depicts a schematic diagram of one embodiment of the transmit interface 110 of the I/O interface 102 of FIG. 5. In particular, the transmit interface 110 includes a scrambler 116 and a serializer 118. The scrambler 116 receives a plurality of parallel plaintext data streams, for example, from the internal chip logic 104. At the scrambler 116, the pseudorandom key sequence is added to or otherwise combined with the parallel plaintext data streams to produce an equal number of parallel ciphertext data streams. The ciphertext data streams are then sent in parallel to the serializer 118 to generate and output a serial ciphertext data stream. The serial ciphertext data stream is transmitted using SPI-5, for example, to a receive interface of another I/O interface on another IC device. An exemplary embodiment of the scrambler 116 is shown in FIG. 8 and described in more detail below.

FIG. 7 depicts a schematic diagram of one embodiment of the receive interface 108 of the I/O interface 102 of FIG. 5. In particular, the receive interface 108 includes a deserializer 120 and a descrambler 122. The deserializer 120 receives a serial ciphertext data stream, for example, from a transmit interface of another I/O interface on another IC device. The deserializer 120 splits the serial ciphertext data stream into a plurality of parallel ciphertext data streams and sends the ciphertext data streams to the descrambler 122 in parallel. The descrambler 122 descrambles the parallel ciphertext data streams to generate a corresponding number of parallel plaintext data streams. More specifically, the descrambler 122 may include specific logic to extract the pseudorandom key sequence from each of the ciphertext data streams, resulting in the plaintext data streams. The plaintext data streams are then sent in parallel to the internal chip logic 104 for appropriate processing. An exemplary embodiment of the descrambler 122 is shown in FIG. 9 and described in more detail below.

FIG. 8 depicts a schematic diagram of one embodiment of the scrambler 116 of the transmit interface 110 of FIG. 6. The depicted scrambler 116 includes exclusive-or (XOR) logic 126, pseudorandom number (PRN) logic 128, and a multiplexor (MUX) 130. Although FIG. 8 specifically shows the XOR logic 126, other embodiments of the scrambler 116 may user another type of combiner to combine the pseudorandom number with the parallel plaintext data streams.

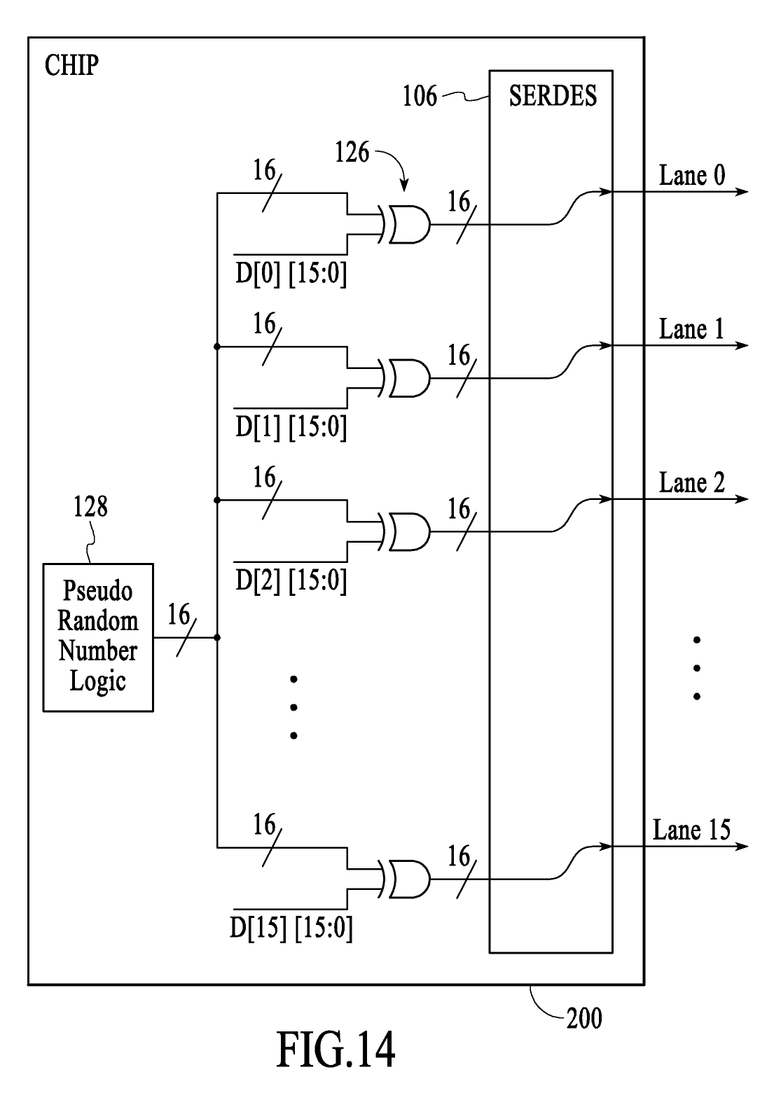

In one embodiment, the PRN logic 128 implements a common X´11+X´9+1 LFSR stream cipher to scramble multiple, parallel plaintext data streams. The X´11+X´9+1 LFSR equation generates 2047 (i.e., 0 through 2046) pseudorandom numbers. In some embodiments, these 2047 numbers are used repeatedly. Based on this characteristic, the fixed 2047-bit pseudorandom key sequence can be pre-calculated and stored in a read-only-memory (ROM) device or implemented by hard-wire logic (e.g., an ASIC). Additionally, the chip implements a 16-bit width input to the XOR logic block 126, and each cycle uses 16 of the 2047 bits to perform an XOR function with the 16-bit data word or control word. In some embodiments, all transmit data (i.e., TDAT[15:0]) and transmit control (i.e., TCTL[3:0]) bits can share one set of 16-bits of a pseudo-random number (refer to FIG. 14 and the accompanying description). Since this is a 16-bit operation, the logic working frequency is one fourth of the receive data clock (RDCLK) speed. The output of the XOR logic block 126 is sent to the serializer 118, as described above.

The plaintext data streams are individually scrambled in parallel by the scrambler 116 at a relatively low frequency. In this way, the scrambler 116 can accommodate a relatively high transmission frequency without implementing complex high frequency domain logic on the chip. For example, the scrambler 116 can operate the 16-bit parallel bus at a frequency speed between 155.5 MHz to 195.3125 MHz, while the IC device 100 continues to support an SPI-5 bit rate of between 2.488 GHz to 3.125 GHz. Other embodiments may operate at other high and low operating frequencies.

Also, scrambling plaintext data streams in parallel using a relatively low frequency allows the scrambler 116 to send data to the current mode logic (CML) pad (SERDES) of the chip. For example, a conventional CML pad (SERDES) design with a 16-bit input parallel bus (or an 8-bit input parallel bus) from the internal logic provides a 16-bit parallel bus at one sixteenth ( 1/16) of the typical operating frequency. Similarly, a CML input pad (SERDES RX side) with a 16-bit output parallel bus (or an 8-bit input parallel bus) to the internal logic provides a 16-bit parallel bus at one sixteenth of the typical operating frequency.

FIG. 9 depicts a schematic diagram of one embodiment of the descrambler 122 of the receive interface 102 of FIG. 7. In particular, the illustrated descrambler 122 includes pre-search logic 132, post-search logic 134, key stream logic 136, PRN logic 138, and plaintext output logic 140. In one embodiment, each descrambler 122 uses an independent X´11+X´9+1 LFSR stream cipher to implement the PRN logic 138. The data output from the descrambler 122 is one plaintext data stream which can be used to determine a training sequence, a control word, or a payload data word.

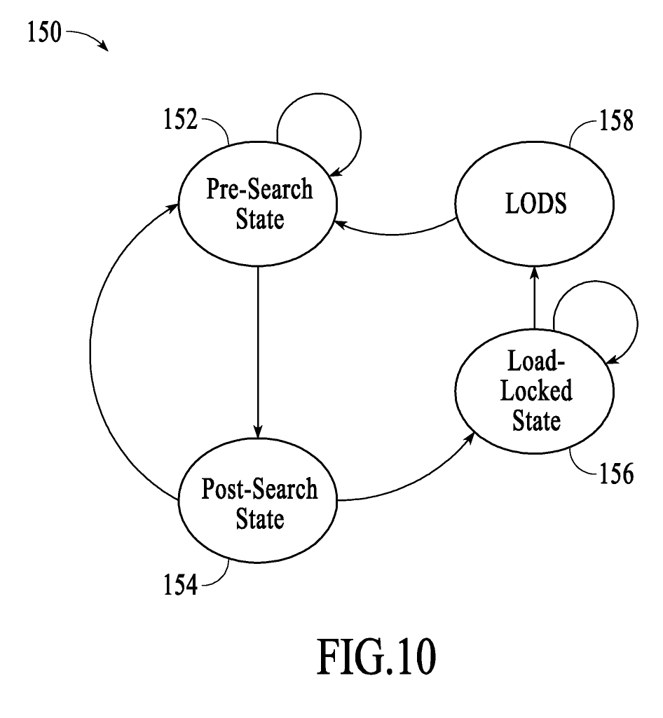

In one embodiment, the logic blocks of the descrambler 122 are used to implement four states, as shown in FIG. 10. FIG. 10 depicts a state diagram of one embodiment of a descrambler process 150 that may be implemented by the descrambler of FIG. 9. The depicted states include a pre-search state 152, a post-search state 154, a load-locked state 156, and a loss of data synchronization (LODS) state 158.

The pre-search state 152 is the initial stage after device power up or after reset. After power up or reset, the descrambler 122 starts to search the incoming data stream for the SPI-5 training sequence. The scrambled training sequence provides a special pattern 142 (e.g., {{16'hffff, 16'h0000}´{9´h0, 2'b11, 14'b0, 2'b11, 5'b0}}), and the descrambler 122 uses this special pattern 142 to recognize the receipt of the training pattern. In the pre-search state 152, the location of the pseudorandom key sequence (i.e., key_stream) is detected and locked. In one embodiment, the locked key_stream is any 32-consistent-bit sequence of the 2047-bit pseudorandom key sequence.

After the descrambler 122 detects the special pattern 142, the descrambler 122 enters the post-search state 154. The post-search state 154 is implemented to check if the locked key_stream generates a correct plaintext data stream. After the post-search state 154 is confirmed, the plaintext output logic 140 generates the correct descrambled data, or plaintext data stream, and the key_stream is locked at the second stage, as depicted by the load-locked state 156. The “locktime” timeout counter starts to increase at one fourth of the RDCLK frequency.

In one embodiment, the PRN logic 138 of the descrambler 122 is synchronized with the PRN logic 128 of the scrambler 116. In this way, the pseudorandom key sequence applied by descrambler 122 to decode the incoming ciphertext is the same as the pseudorandom key sequence applied by the scrambler 116 of the transmit interface 110 of the transmitting I/O interface 100 (from another network chip).

Synchronization of the descrambler 122 can be achieved by using the SPI-5 training pattern. Scrambling the training pattern produces patterns in the ciphertext which the descrambler uses to recognize the receipt of the training pattern. The descrambler 122 uses this information to hypothesize a seed value for the LFSR 138, and to check the resulting plaintext output to determine if synchronization of the transmitting and receiving LFSRs 128 and 138 has been achieved. If the LODS condition is initiated because of an error in receiving data at the descrambler 122, then a training pattern from the other chip's transmitter may be sent again so that the descrambler 122 may reset/reboot and resynchronize with the transmitting scrambler 116.

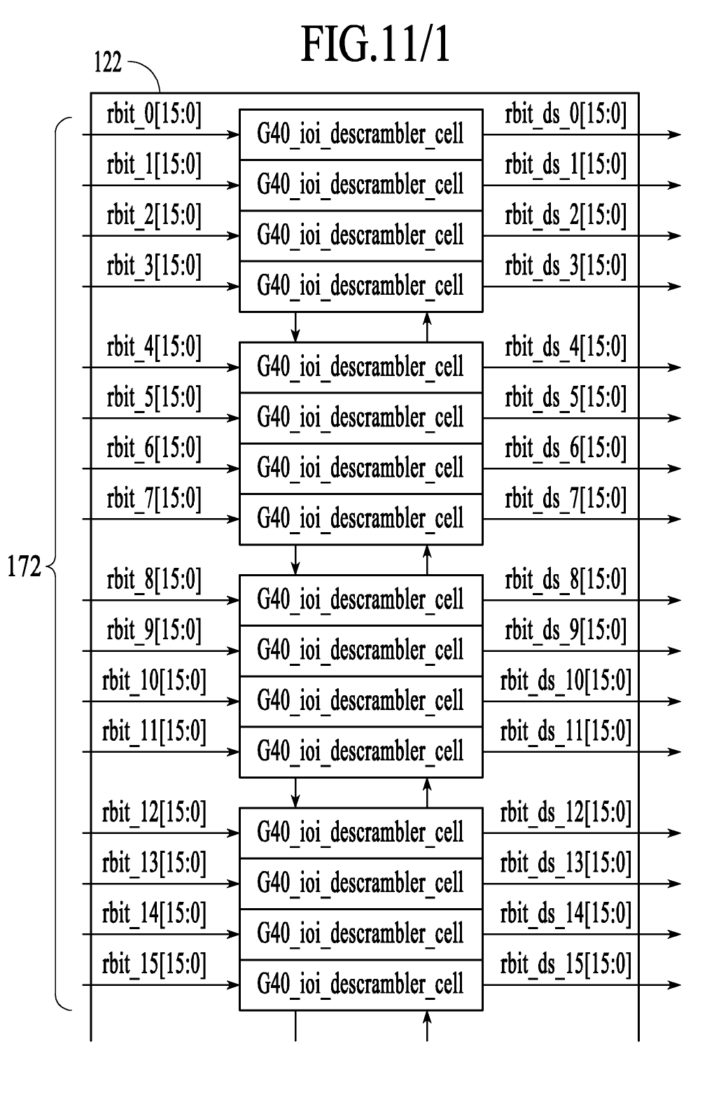

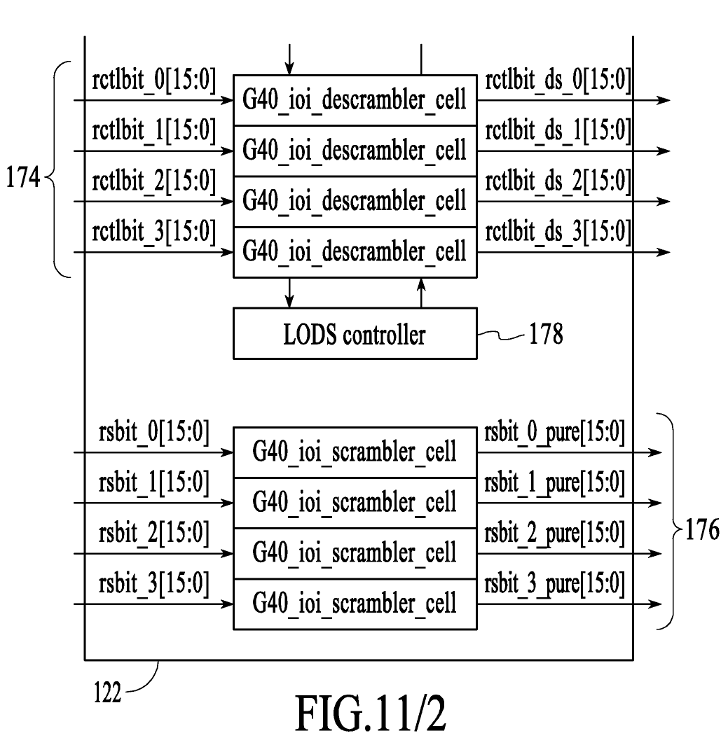

FIG. 11 depicts a schematic diagram of another embodiment of the descrambler 122 of FIG. 7. As explained above, the receive interface 108 of an I/O interface 102 is implemented to decode scrambled data from the transmit interface 110 of another I/O interface 102 (from another network chip). The illustrated descrambler 122 includes twenty descrambler cells 172 and 174 and four scrambler cells 176. In one embodiment, the first sixteen descrambler cells 172 are implemented to descramble incoming data streams (i.e., RDAT[15:0]). The remaining four descrambler cells 174 are implemented to descramble incoming control streams (i.e., RCTL[3:0]). In contrast, the scrambler cells 176 are implemented to scramble status signals (i.e., RSTAT[3:0]) that are sent from the receive interface 108 of the I/O interface 102 to an upstream network device.

In one embodiment, each descrambler cell 172 and 174 can decode 16-bits of data per cycle. Additionally, the standard descrambler cells 172 and 174 can be used to support both the SPI-5 normal or narrow mode based on register setting. The descrambler cells [3], [7], [11], [12], [13], [14], and [15] can serve different purposes depending on normal or narrow mode. As used herein, the normal mode is differentiated from a narrow bus interface mode. In the normal mode, the spi5_desc_inv[19:0] register is set to 20'b0000_{—}1111_{—}0000_{—}0000_{—}0000. In the narrow mode, the spi5_desc_inv[19:0] register is set to 20'b0000_{—}1000_{—}1000_{—}1000_{—}1000.

Each descrambler cell 172 and 174 may have its own set coefficient table which is based on the X´11+X´9+1 LFSR stream cipher. As explained above, the descrambler cells 172 and 174 use the input data pattern and the coefficient table content to determine where the training sequence is and where to perform the “lock” function. Once the “lock” state is set, the output data of the descrambler 122 is generated and 16-bits of data are output per cycle. In the initial stages, the source device keeps sending the training sequence until the receive device sends back “STARVING” on the status line (i.e., RSTAT). In one embodiment, the output of the descrambler cells 172 and 174 for seventeen lanes (e.g., RDAT[15:0] and RCTL) are used to perform one or more deskew function.

Each scrambler cell 176 performs the scrambler functions on the RSTAT bit. In the illustrated embodiment, there are four scrambler cells 176, RSTAT[3:0]. The scrambler cells 176 generate 16-bits of scrambled data per cycle. Each scrambler cell 176 has a coefficient table which is based on the X´11+X´9+1 LFSR stream cipher. The original status data is combined, for example, using an XOR function with the stream cipher coefficient to generate the scrambled RSTAT.

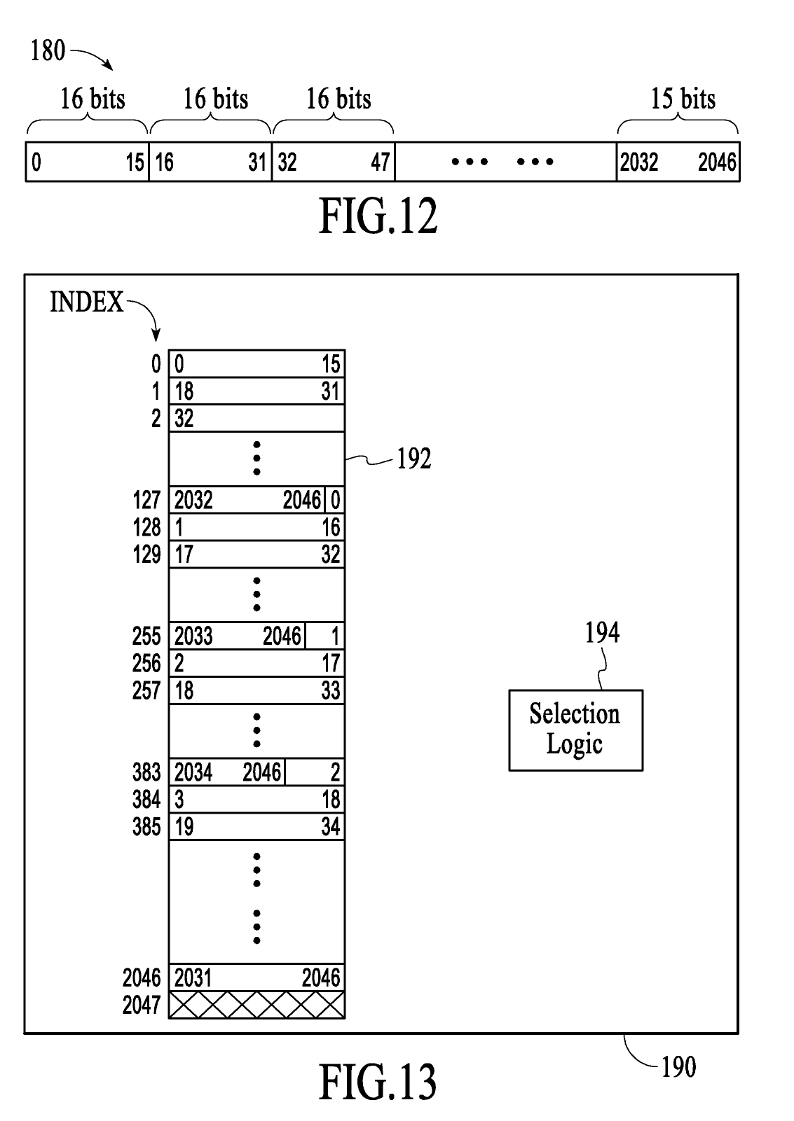

FIG. 12 depicts a schematic diagram of one embodiment of a pseudorandom key sequence 180 that may be implemented in a PRN source within the scrambler 116 of FIG. 8 and the descrambler 122 of FIG. 9. In one embodiment, the PRN source is implemented in an application specific integrated circuit (ASIC). In one embodiment, the PRN logic 128 of the scrambler 116 is implemented in an ASIC. Similarly, the PRN logic 138 of the descrambler 122 may be implemented in an ASIC. In the depicted embodiment, the pseudorandom key sequence 180 includes 2047 bits numbered 0 through 2046. In the figure, the numbers within the illustrated pseudorandom key sequence boxes represent the bit positions. The pseudorandom key sequence 180 is divided into sets, or portions, and each contains sixteen bits, except for the last set which contains 15 bits. For example, the first set includes bits 0 through 15 (sixteen bits), and the last set includes bits 2032 through 2046 (15 bits). For each plaintext data stream, the MUX 130 within the scrambler 116 selects one of the sets, or portions, of the pseudorandom key sequence and scrambles the corresponding plaintext data stream using the selected set of bits.

The MUX 130 may continue to select subsequent sets of bits for each scramble operation until the last set with only fifteen bits is reached. Instead of skipping the last set of bits with only fifteen bits, the ASIC is configured to combine the last fifteen bits (i.e., bits 2032 through 2046) of the pseudorandom key sequence with one bit from the first bit sequence (e.g., bit 0) to output a 16-bit portion of the pseudorandom key sequence. In this way, the bit sets may be formed by wrapping, or combining, one or more bits from the end and one or more bits from the beginning of the pseudorandom key sequence. Using similar wrapping techniques in a repetitive manner, a single pseudorandom key sequence can be used to provide a wide variety of bit sets for scrambling incoming plaintext data streams.

FIG. 13 depicts a schematic diagram of one embodiment of an IC device 190 with read-only memory (ROM) 192 that may be implemented in a PRN source within the scrambler 116 of FIG. 8 and the descrambler 122 of FIG. 9. In one embodiment, the PRN source is implemented as a field programmable gate array (FPGA). Similarly, the PRN source may be implemented within the PRN logic 138 of the descrambler 122. The depicted IC device 190 includes read-only memory (ROM) 192 and selection logic 194. The ROM 192 stores a pre-calculated pseudorandom key sequence, with each line, or entry, of the ROM 192 storing a bit set (e.g., 16 bits). The lines of the ROM 192 are indexed for selection by the selection logic 194.

In the illustrated embodiment, the ROM 192 stores sixteen copies of the pseudorandom key sequence, with each copy beginning at the bit position following the last bit (e.g., bit 2046) of the previous copy of the pseudorandom key sequence. For example, bit 0 of the second copy begins on line 127, in the last bit position of the line, right after bit 2046 of the first copy. Similarly, bit 0 of the third copy begins on line 255, in the second to last bit position of the line, right after bit 2046 of the second copy. Since bit 0 of the third copy occupies the second-to-last bit position of the line, bit 1 of the third copy occupies the last bit position of the same line. In this way, the indexed lines of the ROM 192 provide a variety of sets of bits, similar to wrapping the last bits of the pseudorandom key sequence shown in FIG. 12 and described above. With sixteen copies of the pseudorandom key sequence stored in the ROM 192, line 2047 of the ROM 192 is empty because a total of 16 bits are wrapped to the previous line. More specifically, bits 2031 through 2046 of the sixteenth copy are on line 2046, instead of line 2047, of the ROM 192.

Using the lines of bits stored in the ROM 192, the selection logic 194 can be invoked to index into the ROM 192 and obtain any of the 16-bit combinations. The selected portion of bits is then used to scramble one or more plaintext data streams, as described above. Alternatively, the selected portion of bits may be used to descramble one or more ciphertext data streams, as described above.

FIG. 14 depicts a schematic diagram of one embodiment of a chip 200 to implement the transmit interface 110 of FIG. 5. The depicted chip 200 includes PRN logic 128, as described above, a series of XOR logic 126, and a serializer/deserializer (SERDES) 106. In the illustrated embodiment, the PRN logic 128 is connected to all of the XOR logic blocks 126 via a multi-bit (e.g., 16 bits) bus or other parallel communication channels. In an alternative embodiment, the PRN logic 128 may be connected to multiple, but less than all, XOR logic blocks 126. Other embodiments may use individual PRN logic 128 for each XOR logic block 126.

The other input of each of the XOR logic blocks 126 is coupled to a data channel. Although sixteen data channels (i.e., D[0] through D[15]) are shown, other embodiments may have fewer or more data channels and corresponding XOR logic blocks 126. Additionally, each data channel may have more or less than sixteen bits. Each of the XOR logic blocks 126 is connected to the SERDES 106, which outputs one or more ciphertext data streams on a corresponding number of lanes. In some embodiments, the SERDES 106 serializes the incoming parallel ciphertext data streams from the various XOR logic blocks 126 and outputs a single, serial ciphertext data stream.

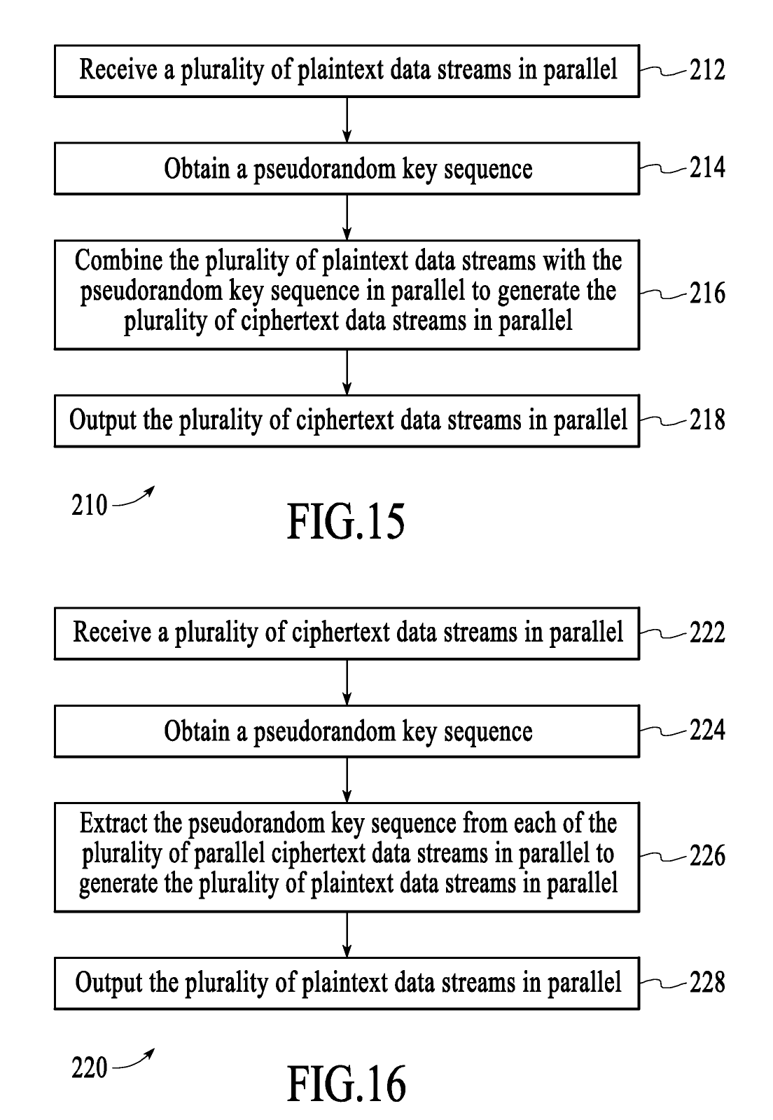

FIG. 15 depicts a flow chart diagram of one embodiment of a method 210 for implementing a transmit interface such as the transmit interface 110 of FIG. 6. Although the transmit interface method 210 is described in conjunction with the transmit interface 110 of FIG. 6, some embodiments of the transmit interface method 210 may be implemented with other types of transmit interfaces.

In the illustrated transmit interface method 210, at block 212, the scrambler 116 receives a plurality of plaintext data streams in parallel. As explained above, the plurality of plaintext data streams may originate from the internal chip logic 104. At block 214, the scrambler 116 obtains a pseudorandom key sequence. At block 216, the scrambler 116 combines the plurality of plaintext data streams with the pseudorandom key sequence in parallel to generate the plurality of ciphertext data streams in parallel. After the parallel ciphertext data streams are generated, then at block 218 the scrambler 116 outputs the ciphertext data streams in parallel, for example, to the serializer 118, as described above. The depicted transmit interface method 210 then ends.

Other embodiments of the transmit interface method 210 may include additional operations. For example, in some embodiments of the transmit interface method 210, the serializer 118 serializes the plurality of parallel ciphertext data streams to generate a serial ciphertext data stream. Additionally, the serializer 118 may output the serial ciphertext data stream at a data transmission rate that is multiple times (e.g., 16 times) faster than the data transmission rate of the scrambler 116.

FIG. 16 depicts a flow chart diagram of one embodiment of a method 220 for implementing a receive interface such as the receive interface 108 of FIG. 7. Although the receive interface method 220 is described in conjunction with the receive interface 108 of FIG. 7, some embodiments of the receive interface method 220 may be implemented with other types of receive interfaces.

In the illustrated receive interface method 220, at block 222, the descrambler 122 receives a plurality of ciphertext data streams in parallel. In one embodiment, the descrambler 122 receives the plurality of ciphertext data streams from the deserializer 120. At block 224, the descrambler 122 obtains a pseudorandom key sequence. At block 226, the descrambler 118 extracts the pseudorandom key sequence from each of the plurality of parallel ciphertext data streams in parallel to generate the plurality of plaintext data streams in parallel. After the parallel plaintext data streams are generated, then at block 228 the descrambler 118 outputs the plurality of plaintext data streams in parallel, for example, to the internal chip logic 104.

Other embodiments of the receive interface method 220 may include additional operations. For example, in some embodiments of the receive interface method 220, the deserializer 120 deserializes a serial ciphertext data stream to generate a plurality of parallel ciphertext data streams. The deserializer 120 may receive the serial ciphertext data stream at a first data transmission rate that is substantially higher than a second data transmission rate of the parallel ciphertext data streams and the parallel plaintext data streams.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An integrated circuit (IC) device interface comprising:
a scrambler to combine a plurality of plaintext data streams and a pseudorandom key sequence, wherein the scrambler comprises:
a pseudorandom number (PRN) source to provide a pseudorandom number, wherein the pseudorandom key sequence is based on the pseudorandom number; and
a combiner coupled to the PRN source, the combiner to receive the plurality of plaintext data streams in parallel and to output a corresponding plurality of ciphertext data streams in parallel.

2. The IC device interface of claim 1, further comprising a serializer coupled to the scrambler, the serializer to assemble the plurality of parallel ciphertext data streams into a serial ciphertext data stream, wherein a first data transmission rate of the plurality of parallel plaintext data streams and the plurality of parallel ciphertext data streams is a fraction of a second data transmission rate of the serial ciphertext data stream.

3. The IC device interface of claim 2, further comprising:
a descrambler to separate the pseudorandom key sequence out of a second plurality of parallel ciphertext data streams to generate a corresponding second plurality of parallel plaintext data streams; and
a deserializer coupled to the descrambler, the deserializer to receive a second serial ciphertext data stream at the second data transmission rate from another IC device interface and to split the second serial ciphertext data stream into the second plurality of parallel ciphertext data streams at the first data transmission rate.

4. The IC device interface of claim 1, wherein the scrambler is further configured to implement an X´11+X´9+1 linear feedback shift register (LFSR) stream cipher.

5. The IC device interface of claim 4, wherein the PRN source comprises:
an application specific integrated circuit (ASIC) to implement the X´11+X´9+1 LFSR stream cipher to generate the pseudorandom number; and
a multiplexor coupled to the ASIC, the multiplexor to select a number of bits from the pseudorandom number to scramble the plurality of plaintext data streams in parallel.

6. The IC device interface of claim 5, wherein the combiner comprises exclusive-or (XOR) logic to combine the number of selected bits of the pseudorandom number with the plurality of plaintext data streams in parallel.

7. The IC device interface of claim 6, wherein the ASIC is further configured to provide consecutive, non-overlapping sets of bits from the pseudorandom number to the multiplexor over a first series of XOR operations and to provide shifted sets of bits from the pseudorandom number to the multiplexor over a second series of XOR operations, wherein each of the shifted sets of bits is non-overlapping relative to other shifted sets of bits and is shifted relative to at least one of the sets of bits used for the first series of XOR operations.

8. The IC device interface of claim 4, wherein the PRN source comprises:
a read-only memory (ROM) to store the pseudorandom key sequence, wherein the pseudorandom key sequence is pre-calculated; and
selection logic coupled to the ROM, the selection logic to index a line of the ROM to obtain a corresponding set of bits of the pseudorandom key sequence.

9. The IC device interface of claim 8, wherein the combiner comprises exclusive-or (XOR) logic to combine the set of bits of the pseudorandom key sequence from the ROM with the plurality of plaintext data streams in parallel.

10. An integrated circuit (IC) device interface comprising:
a descrambler to separate a pseudorandom key sequence out of a plurality of parallel ciphertext data streams, wherein the descrambler comprises:
a pseudorandom number (PRN) source to provide a pseudorandom number, wherein the pseudorandom key sequence is based on the pseudorandom number; and
key stream logic coupled to the PRN source, the key stream logic to receive the plurality of parallel ciphertext data streams and to generate a corresponding plurality of parallel plaintext data streams.

11. The IC device interface of claim 10, wherein the descrambler further comprises:
pre-search logic coupled to the key stream logic, the pre-search logic to detect the pseudorandom key sequence within a portion of the plurality of parallel ciphertext data streams;
post-search logic coupled to the pre-search logic, the post-search logic to determine if the plurality of parallel plaintext data streams are correct; and
plaintext output logic coupled to the post-search logic, the plaintext output logic to output the plurality of parallel plaintext data streams.

12. The IC device interface of claim 10, further comprising a deserializer coupled to the descrambler, the deserializer to receive a serial ciphertext data stream from another IC device interface and to split the serial ciphertext data stream into the plurality of parallel ciphertext data streams, wherein a first data transmission rate of the plurality of ciphertext data streams and the plurality of plaintext data streams is a fraction of a second data transmission rate of the serial ciphertext data stream.

13. The IC device interface of claim 12, further comprising a serializer coupled to the deserializer, the serializer to assemble a second plurality of parallel ciphertext data streams at the first data transmission rate into a second serial ciphertext data stream at the second data transmission rate for transmission to the other IC device interface.

14. The IC device interface of claim 12, further comprising a scrambler coupled to the serializer, the scrambler to combine a second plurality of parallel plaintext data streams and the pseudorandom key sequence to generate the second plurality of parallel ciphertext data streams.

15. An input/output (I/O) interface for an integrated circuit (IC) device, the I/O interface comprising:
a transmit interface with a scrambler, the scrambler comprising:
a scrambler pseudorandom number (PRN) source to provide a scrambler pseudorandom number; and
a combiner coupled to the scrambler PRN source, the combiner to combine the scrambler pseudorandom number with each of a plurality of plaintext data streams in parallel to generate a corresponding plurality of ciphertext data streams in parallel;
a receive interface with a descrambler, the descrambler comprising:
a descrambler pseudorandom number (PRN) source to provide a descrambler pseudorandom number; and
key stream logic coupled to the descrambler PRN source, the key stream logic to extract the descrambler pseudorandom number from a second plurality of ciphertext data streams in parallel to generate a second plurality of plaintext data streams in parallel.

16. The I/O interface of claim 15, further comprising a serializer coupled to the transmit interface, the serializer to assemble the plurality of parallel ciphertext data streams into a serial ciphertext data stream for transmission to another I/O interface of another IC device, wherein a first data transmission rate of the plurality of the parallel plaintext data streams and the plurality of parallel ciphertext data streams is a fraction of a second data transmission rate of the serial ciphertext data stream.

17. The I/O interface of claim 15, further comprising a deserializer coupled to the receive interface, the deserializer to receive a second serial ciphertext data stream from another I/O interface of another IC device and to split the second serial ciphertext data stream into the second plurality of parallel ciphertext data streams, wherein a first data transmission rate of the second plurality of parallel plaintext data streams and the second plurality of parallel ciphertext data streams is a fraction of a second data transmission rate of the second serial ciphertext data stream.

18. The I/O interface of claim 15, wherein the transmit interface and the receive interface are configured to support a transmission mode that is compliant with a System Packet Interface Level 5 (SPI-5) protocol.

19. The I/O interface of claim 15, wherein the receive interface is configured to communicate the plurality of parallel plaintext data streams to internal chip logic of the IC device, and the transmit interface is configured to receive the second plurality of plaintext data streams from the internal chip logic of the IC device.

20. A method for implementing a transmit interface for an integrated circuit (IC) device, the method comprising:
receiving a plurality of plaintext data streams in parallel at a first data transmission rate;
obtaining a pseudorandom key sequence;
combining the plurality of plaintext data streams with at least a portion of the pseudorandom key sequence to generate a corresponding plurality of ciphertext data streams in parallel; and
outputting the plurality of ciphertext data streams in parallel at the first data transmission rate.

21. The method of claim 20, further comprising:
serializing the plurality of parallel ciphertext data streams to generate a serial ciphertext data stream; and
outputting the serial ciphertext data stream at a second data transmission rate, wherein the first data transmission rate is a fraction of the second data transmission rate.

22. The method of claim 21, further comprising invoking hard-wire logic to generate an X´11+X´9+1 linear feedback shift register (LFSR) stream cipher to scramble the plurality of parallel plaintext data streams.

23. The method of claim 20, further comprising:
storing the pseudorandom key sequence on a read-only memory (ROM); and
obtaining the pseudorandom key sequence from the ROM.

24. A method for implementing a receive interface for an integrated circuit (IC) device, the method comprising:
receiving a plurality of ciphertext data streams in parallel at a first data transmission rate;
obtaining a pseudorandom key sequence;
extracting the pseudorandom key sequence from each of the plurality of parallel ciphertext data streams to generate a corresponding plurality of plaintext data streams in parallel; and
outputting the plurality of plaintext data streams in parallel at the first data rate.

25. The method of claim 24, further comprising:
receiving a serial ciphertext data stream at a second data transmission rate, wherein the first data transmission rate is a fraction of the second data transmission rate; and
deserializing the serial ciphertext data stream into the plurality of parallel ciphertext data streams.
